(19) United States
(12) Patent Application Publication
(10) Pub. No.: US 2004/0180192 A1
(43) Pub. Date: Sep. 16, 2004

(54) Cooking utensils with thermally sprayed coating and method for the production of said coating

(76) Inventors: Peter Heinrich, Germering (DE); Werner Krommer, Landshut (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/701,070

(22) Filed: Nov. 5, 2003

Related U.S. Application Data
(63) Continuation of application No. PCT/EP02/04873, filed on May 2, 2002.

(30) Foreign Application Priority Data
May 5, 2001 (DE) 101 21 933.4
May 23, 2001 (DE) 101 25 353.2

(51) Int. Cl. B05D 1/08

(52) U.S. Cl. 428/327; 427/446; 428/328

(57) ABSTRACT

A cooking utensil with a thermally sprayed coating and a method for coating a cooking utensil by thermal spraying, high-speed flame spraying, and plasma spraying are provided. The plastic spray particles, which provide non-sticking properties but char at high temperatures, and the oxide particles, which require heat and provide high scratch resistance, are applied separately at a distance from one another. The plastic particles are fed from a powder tube, which is placed closer to the work piece than the oxide particle supply site.

### CROSS REFERENCE TO RELATED APPLICATIONS

This application is a continuation of international patent application no. PCT/EP02/04873, filed May 2, 2002, designating the United States of America, the entire disclosure of which is incorporated herein by reference. Priority is claimed based on Federal Republic of Germany patent application no. DE 101 21 933.4, filed May 5, 2001, and based on Federal Republic of Germany patent application no. DE 101 25 353.2, filed May 23, 2001.

### FIELD OF THE INVENTION

The invention relates to a method of coating cooking utensils by means of thermal spraying. Layer-forming plastic particles and oxide particles are fed to a spraying jet, the plastic particles and oxide particles being fed separately and—viewed in the spraying direction—at a mutual distance, with the adding of the plastic particles taking place farther away from the spraying nozzle than the adding of the oxide particles. The invention also relates to corresponding cooking utensils.

### BACKGROUND OF THE INVENTION

Thermal spraying methods are essentially characterized in that, as a rule, they permit uniformly applied high-quality coatings. Plasma spraying and high-speed flame spraying are characterized by particularly good adhesive properties on the substrate and by particularly dense sprayed layers.

Cooking utensils can be coated to prevent the baking-on or sticking of food prepared in these utensils. This non-stick layer usually consists of plastic materials, such as PTFE (polytetrafluoroethylene). In this case, fractions of hard materials, usually the oxides A1₂O₃ or Al₂O₂TiO₂, provide a high resistance to scratching. Base materials for the utensils are generally aluminum, aluminum alloys, cast iron or special steel. In addition to the method of thermally spraying to apply the coating, to which this invention relates and in which plastic particles and oxide particles are used as spraying particles, it is currently also customary to provide a scratch-resistant coating with a non-stick surface sealing in a second processing step in order to achieve the desired combination of non-stick and scratch-resistant characteristics. An example of a method for coating of cooking utensils is described in French Patent Document FR 2784280. A mixture of a metallic and ceramic powder is used for the coating, to which mixture PTFE can also be added as an additional constituent.

The above-mentioned oxides and plastic materials are used for coating of cooking utensils. One disadvantage of the thermally sprayed coatings on cooking utensils known in the current state of the art is the fact that, as a result of the method, these contain only a small fraction of the plastic material. Different methods exist for placing plastic materials and oxides in the coating. For example, the plastic material can be enclosed in the oxide powder in order to avoid its burning in the flame. This compound is then used for flame spraying. This presents the problem of an insufficient concentration of the plastic material and its irregular distribution. In the case of the plasma spraying method, the plastic material and the oxide are already mixed before the spraying. However, this becomes problematic in the case of a higher plastic fraction, which is desirable for good non-stick properties, because the plastic material starts to burn and evaporate when it constitutes a larger fraction.

In Japanese Patent Document JP 02217458, the separate adding of ceramic and plastic powder during flame spraying is described. The ceramic powder is added into the hot flame, while the easily melting plastic powder is only added close to the surface to be coated.

### SUMMARY OF THE INVENTION

In an embodiment, it is an object of the present invention to provide a method of the initially mentioned type by means of which it is permitted to increase the non-stick characteristic, which is based on the plastic materials, and the scratch resistance, which results from the oxides, of the coated cooking utensils.

This object is achieved in that the plastic fraction is increased during the coating in a steady or sudden manner, the coating taking place in one operation. The plastic and oxide particles are added separately to the spraying jet. As a result of this separate adding, the addressed spraying particles can be mutually adjusted at a largely arbitrary ratio. This is because the plastic particles are fed into the spraying jet in such a manner that the thermal energy of the spraying jet has decreased to such an extent that their potential combustion and evaporation is largely excluded. By means of this method, it becomes possible to provide the cooking utensils with a coating which, on the one hand, contains a sufficiently large quantity of plastic particles and, on the other hand, contains a sufficiently large fraction of oxidic hard materials in order to ensure good non-stick properties while the resistance to scratching is high. In another embodiment, the plastic fraction is increased in a steady or sudden manner during the coating, the coating taking place in one operation. It thereby becomes possible to define the plastic-particle-to-oxide-particle ratio as desired and to apply it in a single working step. An additional working step during the manufacturing of the cooking utensils, as required in the case of the coating with a subsequent surface sealing, is eliminated, whereby the manufacturing is simplified and its costs are reduced.

In an embodiment, in addition to the oxide, a plastic material is preferably fed into the spraying jet in a relatively large quantity, specifically as a fraction of up to 80% by volume of the total quantity of the spraying particles. By means of this high plastic fraction, very good non-stick properties are achieved.

In an embodiment, plastic material fractions of from 10 to 70% by volume, preferably 30 to 60% by volume, are contained in the spraying material.

The plasma spraying technique and the high-speed flame spraying technique are advantageously used for the method according to the invention.

In an embodiment, the distance for adding the plastic particles into the spraying jet is advantageously selected to be relatively far away from the spraying nozzle at a point where the thermal energy in the spraying jet has decreased to such an extent that the plastic particles only start to melt but no longer burn or evaporate. In contrast, the oxide particles are fed into the spraying jet at a point of high thermal energy, because these have to be altered in the spraying jet in order to form a scratch-resistant coating.

In another embodiment, the angle at which the spraying particles are added is selected to be between 30° and 150° relative to the spraying direction.

Preferably, AL₂O₃ or AL₂O₂TiO₂ are used as oxides.

All gases known for thermal spraying can be used as gases for this purpose as well as their mixtures, such as propane, propene, ethylene, acetylene, hydrogen, oxygen, and the inert gases.

PTFE is preferably used as the plastic material.

With respect to the cooking utensils, the object of the present invention is achieved in that a thermally sprayed, scratch-resistant non-stick coating of plastic material and oxides is applied. The coating has a fraction of the plastic material in the overall quantity of the spraying particles of up to 80% by volume, which is characterized in that, within a coating sprayed on in one operation, the fraction of the plastic material increases in a steady or sudden manner, and only the uppermost layer reaches a plastic fraction of up to 80% by volume in the spraying material. The high plastic fraction in the coating thereby provides good non-stick properties.

As a result of the increasing plastic fraction, which is adjusted as desired, the resistance to scratching can be increased without impairing the non-stick properties. In this case, the coating consists of a single layer and its characteristics are defined by the layer itself and not by characteristics of a combination of the base coating and the surface sealing.

The coating of the cooking utensils is applied by means of plasma spraying or high-speed flame spraying.

Advantageously, the body of the cooking utensils consists of aluminum, aluminum alloys, cast iron or special steel.

Other objects, advantages and novel features of the present invention will become apparent from the following detailed description of the invention when considered in conjunction with the accompanying drawings.

### BRIEF DESCRIPTION OF THE FIGURES

FIG. 1 schematically shows an apparatus for forming a coating on a work piece according to the present invention.

### DETAILED DESCRIPTION OF THE EMBODIMENTS

In the following, the invention will be explained in detail by means of an example with advantageous variants:

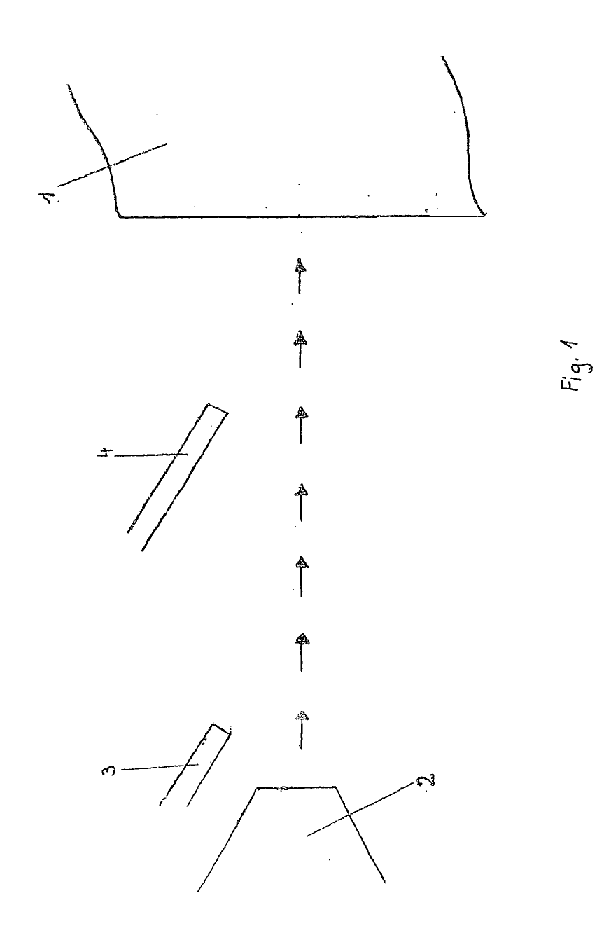

In the example, a method of producing a coating with 40% by volume plastic material is described by means of FIG. 1, in which the plastic fraction increases continuously from 0 to 60% by volume in the overall quantity of the spraying particles.

By means of FIG. 1, the method according to the invention of producing a coating with 40% by volume plastic material is introduced in an advantageous further development and the feeding of the spraying particles is explained. For the thermal spraying, a spray gun is used which operates according to the conventional technique of high-speed flame spraying. The spray gun ends with a nozzle 2. The workpiece 1, thus the cooking utensil, is situated at a distance of 30 cm in front of the nozzle 1 of the flame sprayer. At a distance of 3 cm, the oxide powder is fed from a powder tube 3 at an angle of 30°. Another apparatus for the feeding of the plastic particles is situated at a distance of 20 cm in front of the nozzle 2. From a tube 4, the plastic particles are fed to the spraying jet also at a 30° angle. As an alternative, the oxide powder may also be fed directly into the spray gun, and only the plastic particles are fed externally via a powder tube 4.

At the start of the spraying operation, no plastic particles are fed. According to the example, the successive number of plastic particles is now increased in the spraying jet up to a fraction of 60% by volume of the overall quantity of the spraying material. A sprayed layer is created in this manner in which the plastic fraction increases from the body of the cooking utensil toward the surface and which is particularly distinguished by its non-stick properties, its scratch resistance and its durability.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of coating cooking utensils by thermal spraying, comprising:
adding plastic particles and oxide particles to a spraying jet; and
forming a coating layer; wherein
the plastic particles and oxide particles are added separately to the spraying jet at a distance from each other along a spraying direction,
the plastic particles are added at a location that is farther away from a spraying nozzle than the location for adding the oxide particles,
the coating layer is formed in a single operation, and
said step of forming a coating layer comprises forming said coating layer with a fraction of plastic material therein increasing from the body of the cooking utensil toward a surface of the coating layer.

2. A method according to claim 1, wherein the fraction of plastic material contained in the coating layer increases continuously from the body of the cooking utensil to the surface of the coating layer.

3. A method according to claim 1, wherein the fraction of plastic material in the coating layer increases abruptly one or more times between the body of the cooking utensil and the surface of the coating layer.

4. A method according to claim 1, wherein the plastic particles comprise up to 80% by volume of a total volume of particles in the spraying jet.

5. A method according to claim 1, wherein the plastic particles comprise between 10% and 70% by volume of a total volume of particles in the spraying jet.

6. A method according to claim 1, wherein the plastic particles comprise between 30% and 60% by volume of a total volume of particles in the spraying jet.

7. A method according to claim 1, wherein the coating layer is formed by plasma spraying or high-speed flame spraying.

8. A method according to claim 1, wherein adding plastic particles and oxide particles to the spraying jet comprises
adding the plastic particles to the spraying jet at a first location wherein the thermal energy in the spraying jet will only start to melt the plastic particles;
adding the oxide particles to the spraying jet at a second location where the spraying jet has a higher thermal energy.

9. A method according to one of claim 1, wherein the plastic particles and oxide particles are added to the spraying jet at an angle between 30° and 150° relative to the spraying direction.

10. A method according to claim 1, wherein the oxide particles comprise Al₂O₃ or Al₂O₂TiO₂.

11. A method according to claim 1, wherein the spraying jet comprises a gas selected from the group consisting of propane, propane, propene, ethylene, acetylene, hydrogen, oxygen, and inert gases.

12. A method according to claims 1, wherein the plastic particles comprise PTFE.

13. A cooking utensil having a thermally sprayed, scratch-resistant non-stick coating made of a plastic material and oxides, the plastic material comprising a fraction of up to 80% by volume of a total quantity of the non-stick coating, wherein the coating is sprayed on in one operation, wherein the fraction of the plastic material increases in a steady or sudden manner between the body of the cooking utensil and the surface of the coating layer, and wherein only the uppermost layer reaches a plastic fraction of up to 80% by volume in the coating.

14. A cooking utensil according to claim 13, wherein the coating is applied by plasma spraying or high-speed flame spraying.

15. A cooking utensil according to claim 13, wherein the body of the cooking utensil comprises a metal selected from the group consisting of aluminum, aluminum alloys, cast iron or special steel.
